(19) United States
(12) Patent Application Publication
(10) Pub. No.: US 2003/0129908 A1
(43) Pub. Date: Jul. 10, 2003

(54) STRETCHABLE, COTTON-SURFACED, NONWOVEN, LAMINATED FABRIC

(76) Inventors: LARRY C. WADSWORTH, KNOXVILLE, TN (US); H. CHARLES ALLEN JR., APEX, NC (US)

Correspondence Address: RICHARD T REDANO, DUANE MORRIS LLP, ONE GREENWAY PLAZA, SUITE 500, HOUSTON, TX, 77046, US

(21) Appl. No.: 09/341,393

(22) PCT Filed: Nov. 18, 1998
(86) PCT No.: PCT/US98/24781

(51) Int. Cl. B32B 5/06; B32B 5/26; D04H 1/00

(52) U.S. Cl. 442/382; 442/416; 442/409; 442/411; 442/401; 442/389

(57) ABSTRACT

A stretchable nonwoven, laminated fabric having one or more cotton containing surface layers thermally bonded to one or both sides of a thermoplastic filament fiber core layer and a method for fabricating the fabric. These fabrics after being subjected to a heat-stretching process can provide instantaneous elastic recoveries of 83% to 93% for 50% extension. Furthermore, the fabric exhibits a hand similar to cotton knits, good strength, good wetting, good wicking good water retention, and minimal linting characteristics and can be used for medical applications. Consolidated nonwoven laminated fabrics are also disclosed which can provide instantaneous elastic recovery.

### RELATED PATENT APPLICATION

This application benefits of the earlier filing date of provisional application serial No. 60/066,179, filed Nov. 18, 1997, which is incorporated in its entirety into this patent application.

### BACKGROUND OF THE INVENTION

1. Field of the Invention

This invention relates generally to a nonwoven fabric formed by laminating cotton containing surface layers to a core layer of unbonded thermoplastic filament fibers.

2. Description of the Prior Art

Nonwoven webs (fabrics) are defined as “sheet or web structures made by bonding and/or interlocking fibers, yarns or filaments by mechanical, thermal, chemical or solvent means.” These webs do not require the conversion of fibers to yarn. Nonwoven webs are also called bonded or engineered webs and are manufactured by processes other than spinning, weaving or knitting, hence the name “nonwovens”. The fibers of a nonwoven web can be substantially randomly laid to form a web wherein some of the fibers are bonded by fiber to fiber fusion, or fiber entanglement, or thermal bonds as by point bonding. The basic structure of all nonwovens is a web of fibers. The basic element of a nonwoven can be a single type of fiber or a combination of different types of fibers. Fibers that are measured in a few centimeters or inches or fractions thereof are called staple fibers. Fibers of extreme length, generally kilometers or miles, are called filament fibers. In fibers, the length must be considerably greater than the diameter, having a ratio of at least 100:1 and usually considerably higher. Cotton fibers may measure from less than 0.5 inches to more than 2 inches in length and have a typical length to diameter ratio of about 1400:1. In the present application, the term “fiber” and “fibers” are intended to include both short (staple) and long (filament) fibers, unless otherwise specifically indicated by identifying the fibers as staple or filament. In nonwoven fabrics, the individual fibers may be in an organized or random arrangement. Tensile, elongation and hand properties are imparted to the web or fabric by the type or types of bonding as well as fiber-to-fiber cohesion and reinforcement by its constituents.

Disposable nonwoven fabrics entered the medical field over four decades ago, beginning with basic paper-like face masks and proceeding through sterilization wrap and specialty drapes and gowns. These medical nonwoven fabrics have proven to be invaluable in products ranging from drape sheets to surgical gowns to adult pads and underpants by utilizing a gamut of nonwoven structures. Nonwoven fabrics now have almost complete acceptance in U.S. hospitals for applications such as surgical caps, masks and shoe covers. Because products made from nonwoven fabrics provide relatively inexpensive, lightweight and effective protection, they have made 90%-100% penetration in operating room usage. Nonwoven fabrics have now outpaced woven fabrics in uses such as surgical gowns and drapes, where they have about a 60%-70% share of the market. The current market for products made using nonwoven fabrics is estimated to exceed one billion dollars annually. With the majority of the medical community being convinced that disposable products made of nonwoven fabrics give the double benefits of superior barrier protection and ease of use, it is only the psychological barrier that needs to be overcome before nonwoven fabrics achieve even greater penetration in the operating room market and elsewhere.

Among the desired properties of a nonwoven laminated fabric for use in medical and sanitary applications are the hand (softness and drapability), wicking, liquid retention, absorptive capacity, and strength of the laminate. Also of importance in acceptance of the nonwoven laminated fabric by the end user is the degree to which the nonwoven laminated fabric approximates the desirable properties of woven fabric, particularly woven cotton. Nonwoven fabrics of man-made fibers generally have the reputation of lacking many of the properties of woven natural fiber fabric, particularly hand, wicking, and liquid absorption and retention. Nonwoven fabrics of man-made fibers often exhibit undesirable chemical properties such as hydrophobicity. Moreover, the surface properties of nonwoven fabrics tend to be smooth, hence exhibiting a slick or oily feel and appearance.

Cotton, by virtue of its unusual chemistry and structure, offers a set of properties including high tensile strength, exceptional absorbent, highly efficient wicking, natural resistance to electrostatic charge build-up, excellent heat resistance and good processability, all of which are important to the manufacture and performance of medical and health care products. Accordingly efforts were made to fabricate nonwoven laminates containing cotton.

Early efforts to use cotton in nonwoven laminated fabric used bleached carded cotton cores with outer layers of meltblown webs (meltblown/cotton/meltblown or MCM laminates). The meltblown webs serve as binder fiber materials during the subsequent thermal point bonding step. Together with the cotton fibers, the meltblown webs impart both the strength and barrier properties of the laminated fabric. A more detailed description of cotton core nonwoven laminated fabrics is provided in U.S. Pat. No. 5,683,794 (L. C. Wadsworth, K. E. Duckett and V. Balasubramanian), which is incorporated herein by reference. The cotton core laminated fabrics were developed for applications such as absorbent pads, towels and wipes, sanitary napkins, diapers, wound dressings, and when treated with a repellent finish may also be used for protective apparel such as surgical drapes and gowns.

In applications where greater strength is required, spunbond webs are used on one side in place of a meltblown web to produce spunbond/cotton/meltblown (SCM) laminated fabrics. Although cotton serves efficiently as an absorbent core, these laminated fabrics still lack aesthetics that could be attained if cotton was on the surface of the laminated fabric.

### SUMMARY OF THE INVENTION

It is an object of the present invention to provide a flexible, nonwoven, laminated fabric having one or more cotton containing surface layers thermally bonded to a thermoplastic fiber core to provide a hand similar to cotton knits.

It is another object of the present invention to provide a stretchable, nonwoven, laminated fabric which exhibits good elastic recovery.

It is another object of the present invention to provide a stretchable/elastic, nonwoven, laminated fabric which exhibits minimal linting.

It is yet another object of the present invention to provide an economical and robust process for fabricating a stretchable, nonwoven, laminated fabric having one or two cotton containing outside layers thermally bonded to a thermoplastic fiber core.

To accomplish the above objectives, the present invention provides stretchable/elastic, nonwoven, laminated fabrics having one or more cotton containing surface layers thermally bonded to one or both sides of a thermoplastic filament fiber core layer and a method for fabricating these fabrics. These fabrics can provide instantaneous elastic recoveries of 83% to 93% for 50% extension. Furthermore, the fabrics exhibit a hand similar to cotton knits, good strength, good wetting, good wicking good water retention, and minimal Tinting characteristics making them suitable for use in medical applications such as isolation gowns, head covers, shoe covers, bed sheets, and pillow cases. They are also suitable for sanitary consumer products such as disposable underwear, towels, wipes, and personal hygiene products.

The inventors have found that it is extremely difficult to produce thermally bonded laminated fabrics of cotton/spunbond (CS), cotton/meltblown (CM), cotton/spunbond/cotton (CSC) or cotton/meltblown/cotton (CMC), because the cotton fibers in unbonded or loosely bonded webs can not efficiently transfer heat to the inner spunbond or meltblown core. Instead, the cotton fibers wrap around the steel calendar rolls.

Nevertheless the inventors determined that it is desirable to produce a laminated fabric with cotton on one or both surfaces, which also has a degree of extensibility and strength. The present invention achieves a degree of extensibility and strength in a laminated fabric having cotton on one or both surfaces by laying webs containing loosely bonded cotton fibers on one or both sides of an unbonded spunbond core so that the cotton fibers can “sink” into the open spaces between the unbonded spunbond filament fibers. The cotton fibers are better entrapped between the spunbond filament fibers so that thermal bonding in the calendar nip can tie the cotton fibers down and render them less likely to pull out or lint. In addition, the thermally bonded fabric has much more flexibility and strength than if a pre-bonded spunbond web was utilized to prepare the thermally bonded laminate.

Another drawback of the thermally bonded MCM, SCM and SCS laminated fabrics has been their lack of extensibility. However, it was demonstrated that they could be subsequently made more elastic by subjecting them to a controlled heating and stretching process called “consolidation.” Heat stretching in the machine direction, or “MD”, providing consolidation and extensibility in the cross-machine “CM” direction is described in detail in U.S. Pat. No. 5,441,550 (C. B. Hassenboehler and L. C. Wadsworth), incorporated herein by reference. Consolidation in the machine direction is described in U.S. Pat. No. 5,599,366 (C. B. Hassenboehler and L. C. Wadsworth), also incorporated herein by reference. The inventors have determined that the fabrics of the present invention can also be made more elastic by consolidation, either in the MD or CD, as required by the circumstances. These fabrics when consolidated in the CD have virtually no elasticity or stretchability in the MD (heat-fixed in the MD) and when consolidated in the MD have virtually no elasticity or stretchability in the CD.

A key aspect of the present invention is the cotton containing surface layer. To achieve the optimum bonding between the web layer and the core layer, the pre-bonding of the web layer must be minimal. The fibers in an unbonded or loosely bonded cotton containing web will more easily intermesh with the core filament fibers during the calendaring step, so that the cotton fibers are less likely to lint or abrade away in the laminated fabric. However, the cotton containing web layers can not be rolled up and unwound without same pre-bonding. Preferably the cotton containing web layers are pre-bonded at the minimum contact area and temperature setting which will allow the web layers to be rolled and unwound, leaving most of the bonding of the cotton fibers and thermoplastic staple fibers to each other to occur during the calendaring step on the spunbond line. Alternatively, the cotton containing surface layer may be fabricated on the spunbond line so that it does not have to be rolled and unwound, and consequently does not have to be pre-bonded.

To achieve adequate bonding of the web layer to the core layer, the web layer should for best results contain thermoplastic fibers blended with the cotton fibers. In order to improve the uniformity of blending and to improve bonding the thermoplastic fibers should preferably approximate the diameter and length of cotton fibers. Webs have been made using staple polypropylene fibers having a length between about 1.0 inches and 1.5 inches with a denier of between about 1.9 and 2.2 (weight in grams per 9000 meters of fiber). However, fibers made using other thermoplastic materials and other sizes are included within the scope of this invention. Such thermoplastics are disclosed in the patents referred to in this text, and are incorporated by reference.

The fabrics of the invention prior to consolidation are characterized by excellent stretchability in both directions (length and width) with limited elastic recovery in both directions, for instance about up to 5 or 10% elasticity in both directions. This distinguishes the fabrics of the invention from those that are consolidated in the CD or MD.

### BRIEF DESCRIPTION OF THE DRAWINGS

FIG. 1 illustrates the apparatus and process for fabricating a stretchable laminated fabric with one cotton-containing surface layer bonded to a filament fiber core layer.

FIG. 2 illustrates a cross sectional view of a two-ply laminated fabric having a cotton containing surface layer bonded to a filament fiber core layer.

FIG. 2A illustrates overlapping cellulosic fibers and thermoplastic staple fibers in the surface layer.

FIG. 3 illustrates a cross sectional view of a three-ply laminated fabric having a cotton containing surface layer bonded to each side of a filament fiber core layer.

FIG. 4 illustrates the apparatus and process for fabricating a stretchable laminated fabric in which the fiber core layer is sandwiched between two cotton-containing surface layers.

FIG. 5 illustrates the apparatus and process for an alternate embodiment for fabricating a stretchable, laminated fabric with a cotton containing surface layer bonded to a filament fiber core layer.

FIG. 6 illustrates the results of strike-through tests performed on sample fabrics fabricated according to the invention.

FIG. 7 illustrates the results of abrasion tests performed on sample fabrics fabricated according to the invention.

### DETAILED DESCRIPTION OF THE PREFERRED EMBODIMENTS

The present invention will be described in detail with reference to the accompanying drawings. The present invention relates to a stretchable laminated nonwoven fabric comprising one or more cotton containing web layers thermally bonded to one or both sides of a thermoplastic filament core layer, wherein the cotton containing web layer(s) are on the surface of the resulting laminated fabric.

A spunbond process for fabricating a web of filament fibers is known in the art. See for instance: Malkey, S. R. and Wadsworth, L. C., “A Review on Spunbond Technology, Part I, International Nonwovens Bulletin, 4-14, 1992, incorporated herein in its entirety. In a spunbond process, continuous thermoplastic polymer filament fibers are extruded onto a conveyor belt, then fed through the nip of a pair of rollers one of which is patterned (a calendar) where the fibers are thermally bonded under temperature and pressure conditions which melt and bond the thermoplastic filament fibers in the contacted areas. While no part of the apparatus and process for fabricating a spunbond web is claimed in this invention, parameters and modifications to a spunbond process to fabricate a stretchable laminated nonwoven fabric having a cotton containing surface layer on one or both surfaces of the resulting laminated fabric and the resulting laminated fabric are the subject of this invention.

### First Embodiment

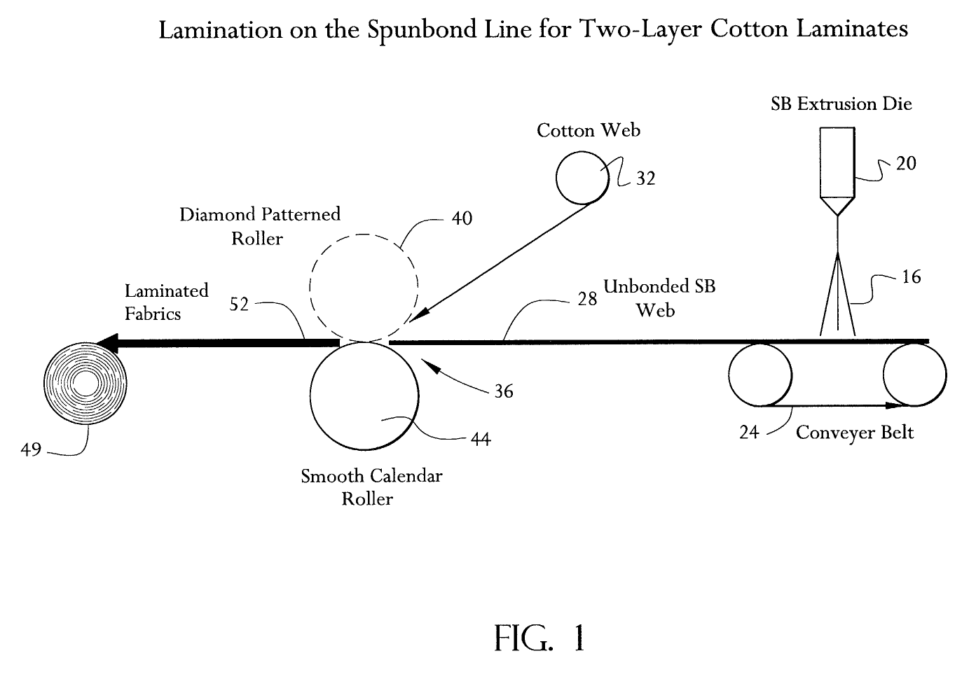

In the first embodiment, a two-ply laminate is fabricated by thermally bonding one pre-bonded surface layer 32, consisting of cotton and thermoplastic staple fibers to a spunbond filament fiber core layer 28. As shown in FIG. 1, man-made thermoplastic filament fibers 16 are extruded through a die 20 onto a conveyor 24 forming an unbonded spunbond core layer 28. A pre-bonded cotton containing web layer 32 is laid on the unbonded spunbond core layer 28. The core layer 28 and the web layer 32 are fed through the nip 36 of a set of heated pressure rollers (calendar) 40, 44. The top pressure roller 40 has a pattern 48 on its surface, preferably a diamond pattern, to contact and bond a percentage of the surface area of the resulting fabric 52. The lower pressure roller 44 has a smooth surface. The web layer 32 can be laid either over the core layer (contacting the patterned pressure roll) or under the core layer (contacting the smooth pressure roll). The laminated fabric is taken up on a roll 49.

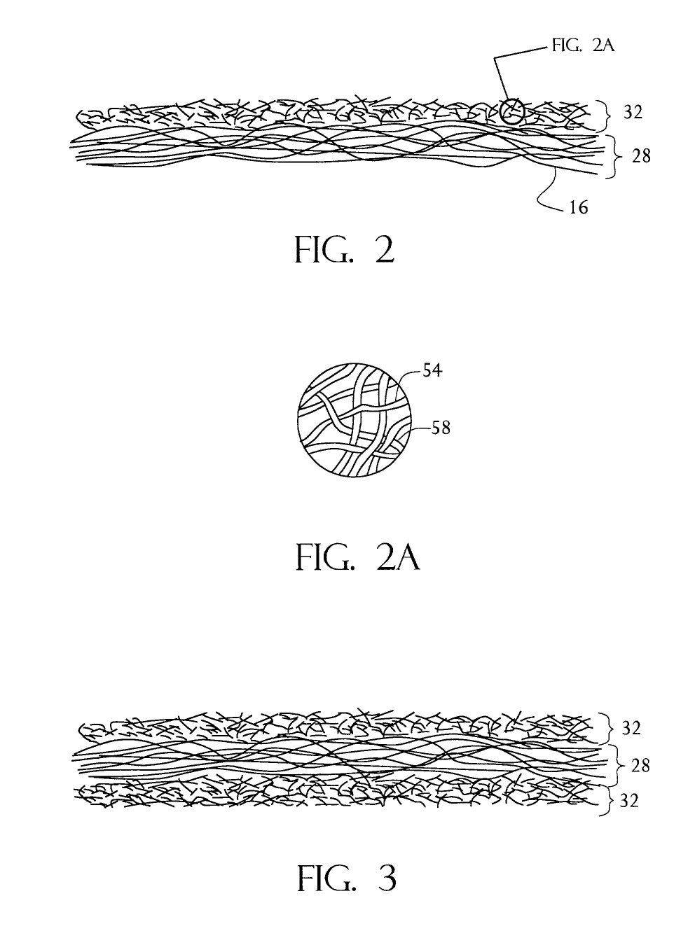

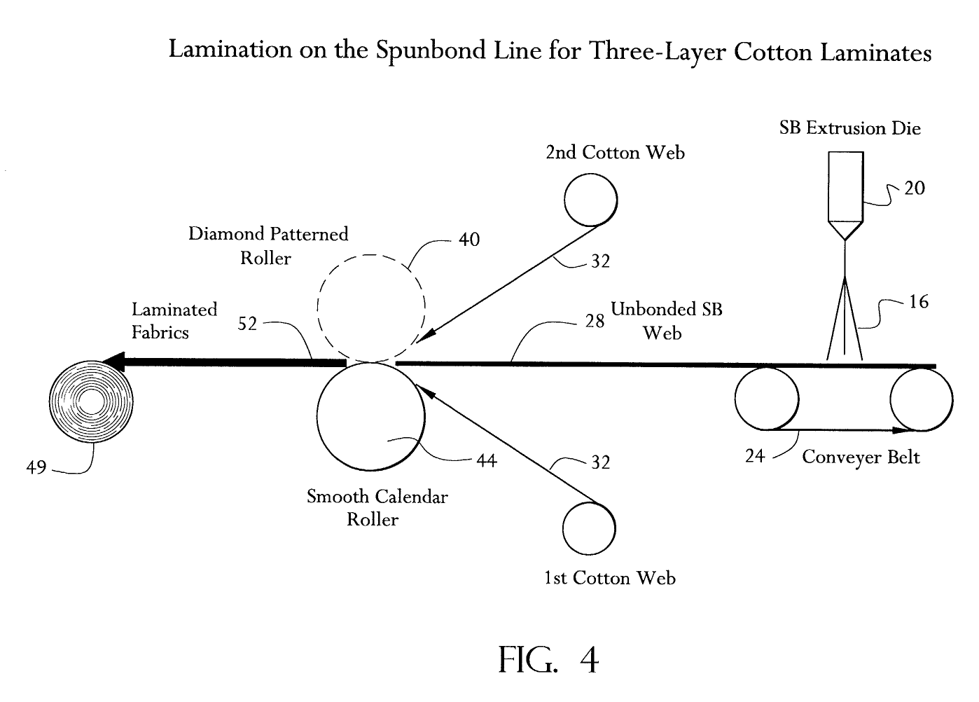

For two-ply and three-ply laminates with a spunbond polypropylene core layer with a weight of 34 g/m² (1.0 oz/yd²) and a 60 weight-% cotton/40 weight-% meltblown polypropylene web layer, as shown in cross-section in FIG. 2, the bonding area is between about 5% and 40% (16.6% in these trials) . The nip pressure is set between about 100 and 800 PLI (450 PLI in these trials). The patterned pressure roller is at a temperature of between about 135° C. and 154° C. (avg. 149° C.). The smooth pressure roller is at a temperature of between about 132° C. and 151° C. (avg. 146° C.). The surface speed with the calendar was 30 meters/min. but vary from 10-500 m/minutes and pressure adjusted as needed.

The extruded filament fibers 16 are composed of a thermoplastic polymer such as polyethylene, polyester, polyamide, or most preferably polypropylene. The thermoplastic filament fibers 16 readily melt, or become soft and sticky under heat and pressure at the contact points in the nip of the thermal calendar to self bond to crossing or overlapping filament fibers 16, and also serve to stick to and bond cotton fibers 54, and especially thermoplastic staple fibers 58 from the pre-bonded surface layer 32 which is placed on one side of the core layer 28 in the first embodiment.

Spunbond webs are especially desirable for the core layer 28, because the filament fibers 16 are continuous in length and they are randomly laid down in the horizontal plane of the web so that one filament is bonded several times, even if there are only a few bonding points. With spunbond thermoplastic webs, a total bonded area of between 5% and 30%, and preferably 15% is required to achieve the optimum strength for the web. In comparison, a staple fiber web would require a bonding area of between 40% and 50% for optimum strength since the short discontinuous staple fibers would pass through fewer bonding sites. Thus a staple fiber web with maximum strength would be much stiffer than the corresponding weight of spunbond web of maximum strength. Furthermore, thermally bonded spunbond webs, even with much less bonded area are generally much stronger than corresponding weights of optimally bonded staple fiber webs.

The diameter of the monocomponent spunbond filament core layer 28 is in the range between about 8 μm and 100 μm, preferably between about 10 μm and 30 μm.

The weight of the core layer 28 can vary depending on the intended use and desired properties of the laminate formed. A lighter spunbond core layer 28 would be less expensive and would result in a softer laminate with better drape. For applications requiring greater strength and abrasion resistance, a heavier spunbond core layer 28 may be required. A heavier spunbond core layer 28 provides more thermoplastic fiber for reinforcing the base spunbond web as well as improving the bonding of the staple fibers 58 and cotton fibers 54 to the filament fibers 16 in the core layer 28. The spunbond core layer has a weight of between about 5 g/m² and 100 g/m², and preferably between 10 g/m² and 50 g/m².

In the first embodiment a pre-bonded surface layer 32 consisting of cotton fibers 54 and thermoplastic staple fibers 58 is laid on the unbonded filament fiber core layer 28. The composition and pre-bonding conditions of the surface layer 32 are critical to the properties of the resulting laminated fabric. The key characteristic of the surface layer 32 is the properties imparted to it by its cotton fibers 54: hand, wicking, absorbency, and strength. However, other cellulosic fibers could be used in place of cotton, such as viscose rayon, flax, jute, hemp, ramie and kenaf. When using the preferred cotton fibers, they have a diameter of between about 5-30, and preferably 8-20 μm. The length may be between about 0.2 inches and 2.0 inches, and preferably between about 0.5 inches and 1.2 inches.

The thermoplastic staple fibers 58 may be composed of any thermoplastic fiber-forming polymer known in the art such as polyester, polyamide, polycarbonate, or most preferably polypropylene. The thermoplastic staple fibers 58 should approximate the size of cotton fibers 54 to enhance the mixing of the cotton and the thermoplastic staple fibers. The thermoplastic staple fibers have a diameter of between 1 denier and 10 denier (g/9000 m of fiber), and preferably between 1.2 denier and 4.0 denier. The length of the thermoplastic staple fibers is between 0.2 inches and 4.0 inches and preferably between 1.0 inches and 1.5 inches.

The cotton fibers 54 and the thermoplastic staple fibers 58 are mixed in a ratio of between about 10 wt-% cotton fibers and 90 wt-% cotton fibers, and preferably between about 20 wt-% cotton fibers and 80 wt-% cotton fibers. The balance of the fibers are thermoplastic staple fibers 58. The cotton fibers 54 and the thermoplastic staple fibers 58 are preferably mixed using a randomizer unit 70 to orient the fibers in both the machine direction (MD) and the cross machine direction (CD) of the web. Preferably, a greater percentage of the fibers are oriented in the MD versus CD by a ratio of between about 2:1 and 5:1. However, without the randomizer unit 70, the ratio of MD to CD would be about 10:1. The web is then passed through a thermal calendar 40, 44 and bonded. The bonding area, pressure and temperature are all set as low as possible while still providing sufficient strength to be rolled up and later unwound for lamination on a spunbond line. Most of the bonding of the cotton/thermoplastic staple fibers to each other and to the core layer preferably occurs during thermal bonding of the laminate on a spunbond line. For a 60 wt-% cotton/40 wt-% polypropylene staple fiber web the pre-bonded area is between 5% and 30% (21% in these trials); the bonding pressure is between 20 and 150 PLI (60 PLI in these samples); and the bonding temperature is between generally about 130° C. and 150° C. (140-145° C. in these trials). The weight of the surface layer 32 is between about 10 g/m² and 60 g/m², and preferably between about 15 g/m² and 40 g/m². To be noted is that each outside layer, whether 1-, 2-, or 3-ply has weight between 10 g/m² and 60 g/m², and preferably between about 15 g/m² and 40 g/m².

### Second Embodiment

The second embodiment is similar to the first embodiment, except that a three-ply laminated fabric, as shown in FIG. 3, is fabricated by bonding a pre-bonded cotton containing surface layer 32 to each side of the core layer 28. One surface layer 32 is laid over the core layer 28, and contacts the patterned pressure roller. A second web layer 32 is laid under the core layer 28, and contacts the smooth pressure roller. The three layers are fed into the calendar nip together.

For a two and three-ply laminated fabric with a spunbond polypropylene core layer (with a weight of 17 g/m²) 28 and two 60 weight-% cotton/40 weight-% polypropylene stable fiber surface layers 32, as shown in cross-section in FIG. 3, the bonding area is between about 5% and 40% (16.6% in these trials). The nip pressure is set between about 200 and 700 PLI (400 PLI here). The patterned pressure roll is at a temperature of between about 132° C. and 151° C. (avg. 146° C.). The smooth pressure roll is at a temperature of between about 129° C. and 149° C. (avg. 143° C.). The speed can vary from 10 to 500 meters/min.

### Third Embodiment

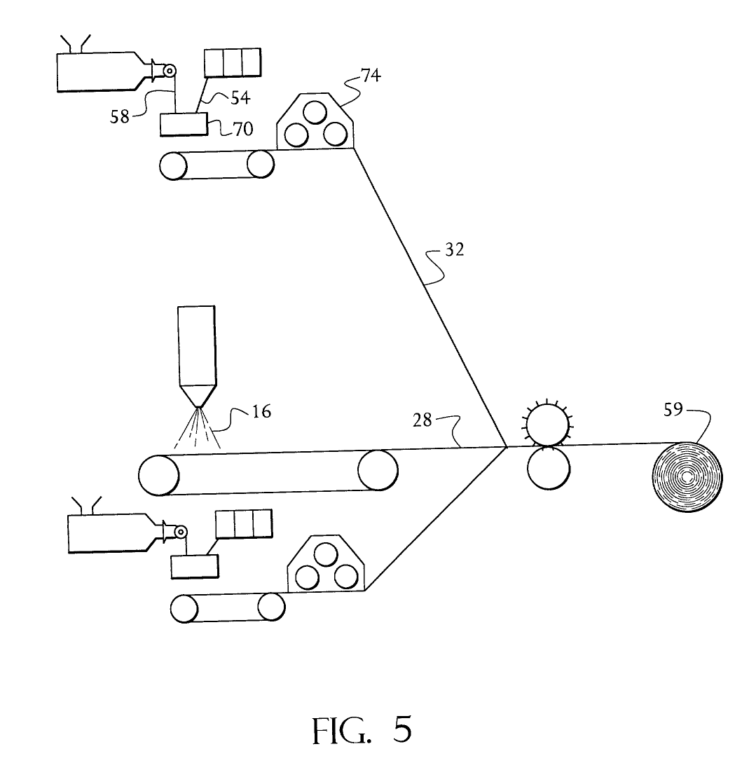

The third embodiment is similar to the second or third embodiment except that the surface layer(s) 32 are not pre-bonded. Instead the surface layer(s) 32 are formed on the spunbond line, as shown in FIG. 5, by feeding cotton fibers 54 and thermoplastic staple fibers 58 through a blender 70, then into an in-line carding unit 74, then into a randomizer 75, and onto a conveyor belt. The cotton/thermoplastic staple fiber web layer(s) 32 are laid on one or both sides of a core layer 28 formed by extruding thermoplastic filament fibers 16 onto a conveyor belt. The unbonded web layer(s) 32 and the unbonded core layer 28 are fed into the nip of a thermal calendar where they are simultaneously self bonded and bonded to each other. The laminated fabric is taken up on a roll 59.

### Fourth Embodiment

The laminated fabrics fabricated according to the first, second and third embodiments have notable flexibility and extendible adequate for many applications. However even greater flexibility and extensibility can be achieved by further processing the fabric using a heat-stretch or consolidation process. Heat is applied to the fabric while it is being drafted in the machine direction for cross-machine direction consolidation. After cooling the cross-machine direction consolidated fabric exhibits improved stretch and recovery characteristics in the cross machine direction. The fabric can also be consolidated in the machine direction by stretching in the cross-machine direction under heat and then allowing to cool or cooling.

The fabric can be consolidated using a draw ratio (wind speed/unwind speed) of between about 1.3 and 2.0 to draw the fabric in the machine direction. Consolidation can be performed in an oven at temperatures of between about 283° F. (139° C.) and 306° F. (152° C.). Instantaneous elastic recovery at 50% extension in the cross-machine direction for cross-machine direction consolidated fabric is between about 83% and 93%.

The following examples are not intended to be limiting the invention, and are only illustrative. One skilled in the art can readily use different thermoplastic fiber-forming polymers and make other changes as may be desirable.

### Experiments

Seven sample fabrics were fabricated in accordance with the present invention. Their compositions and weights are shown in Table 1. As indicated, samples 1, 2, 3, 6 and 7 were prepared using surface layers 32 of TCPP1 which is a carded web consisting of 60 weight-% cotton/40 weight-% polypropylene staple fibers pre-bonded at about 21% of their surface area. The web has a weight of about 0.7 oz/yd². Sample 1 is a two-ply laminated fabric in which a TCPP1 surface layer 32 was bonded to a core layer 28 consisting of a spunbond filament web with a weight of 0.5 oz/yd² (SB1). Scanning electron microscope (SEM) photographs of sample 1 indicate a well defined thermal bond with notable melting and fusing of fibers in the bonded area. Samples 6 and 7 are three-ply laminated fabrics with a TCPP1 surface layer 32 bonded on each side of a core layer 28. Sample 6 has a SB1 core layer 28, and sample 7 has a core layer 28 consisting of a spunbond filament web with a weight of 1.0 oz/yd² (SB2). SEM photographs of sample 6 show a clearly defined thermal bond, although there is not as much melting and fusing as in sample 1. SEM photographs of sample 7 do not show a well defined bond on either side of the thermal bond area. Thus polypropylene spunbond core layers as light as 0.5 oz/yd² would not generally be recommended for three-ply laminates unless the polypropylene staple fiber or other thermoplastic binder fiber content is increased from 40% to between 60% and 80%. However, depending on the end-use, the 0.5 oz/yd² spunbond core could be preferable for two-ply fabrics.

The fabric samples 1, 2, 3, 4, 5, 6 and 7 were consolidated in the cross-machine direction under the conditions indicated in table 2. The actual weights and thickness of the samples after consolidation are listed, as are the instantaneous and time dependant elastic recoveries.

Tests for Instantaneous And Time Dependant Elastic Recoveries

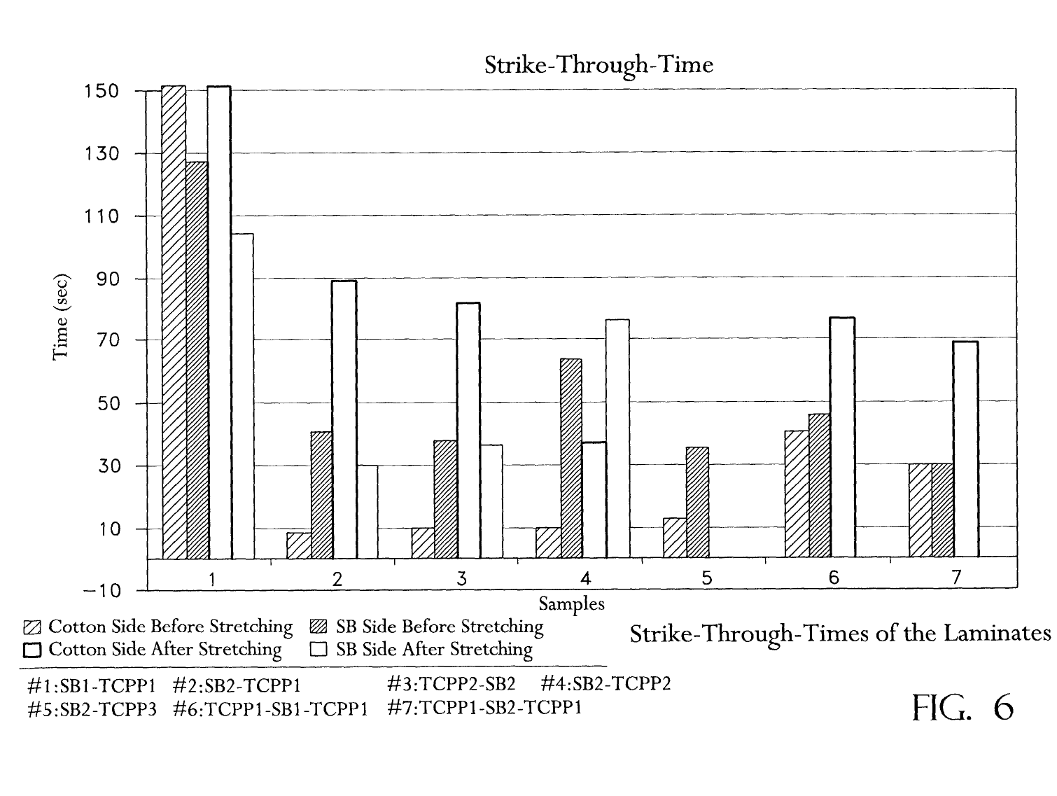

The absorbency properties of the laminated fabric samples were determined using ISO 9073-8: 1995 “Textiles—Test method for nonwovens, Part 8: Determination of liquid strike-through time (simulated urine)”. This test was designed to determine the time required for simulated urine solution to penetrate through a disposable diaper over stock fabric and into an absorbent pad beneath the fabric. In the test, the side of the fabric that would be against the body is placed face up on the standard filter paper blotter and the amount of time for 5 ml. of simulated urine solution to penetrate through to the filter paper is electronically determined. With the two-ply laminates, both the core side and the cotton containing web side were tested since the particular end use would determine which side is against the body. The test with the cotton containing web side down against the filter paper is arbitrarily designated cotton side. With diaper cover stock, it is desirable to have a strike-through time as short as possible. However, in the present invention, it is hoped that the cotton component will increase the absorbency or water holding capacity of the laminates. Thus, the longer the strike-through time, the greater the aqueous holding capacity of the laminates. The absorbency data is shown in FIG. 6. Sample 1 had very high strike-through times as determined with the cotton side against the filter paper, both before and after consolidation. Testing with the core layer against the filter paper also resulted in high strike-through times. Although this sample has the lowest cotton content of 41%, the high strike-through times are believed to be due to liquid barrier properties of the heavier core layer and reduced porosity resulting from the excellent thermal bonds achieved in this sample. After consolidation, strike-through times of greater than 30 seconds were consistently achieved.

Since the invented laminated fabrics are intended for disposable or short wear cycle applications, the standard abrasion tests do not apply. Thus, a special abrasion test was developed using the Taber Dual Abrader 505 to compare the relative bonding strength of the cotton containing outer layer to the core layer. The following test procedure was utilized:

1. The required number of specimens were cut to the dimensions of 120 mm×120 mm.

2. The specimens were conditioned for 24 hours and tested at 65+/−2% relative humidity and 20+/−2° C. (according to ASTM D 1776-85).

3. A small hole (approximately 5 mm in diameter) was made in the center of the specimen to fit over the turntable clamping screw.

4. The metal ring clamping the edges of the specimen to the outer circumference of the turntable were tightened and the center clamping plate was tightened.

5. The abrading wheel was lowered onto the specimen and the tester was turned on. During the abrasion test, the vacuum device on the abrader was operated to suction away abraded particles. The test was stopped after the turntable had rotated 20 cycles with the abrading wheel on the specimen.

6. The specimen was removed and the percentage of peeled-off surface area that was subjected to the abrasion was visually estimated.

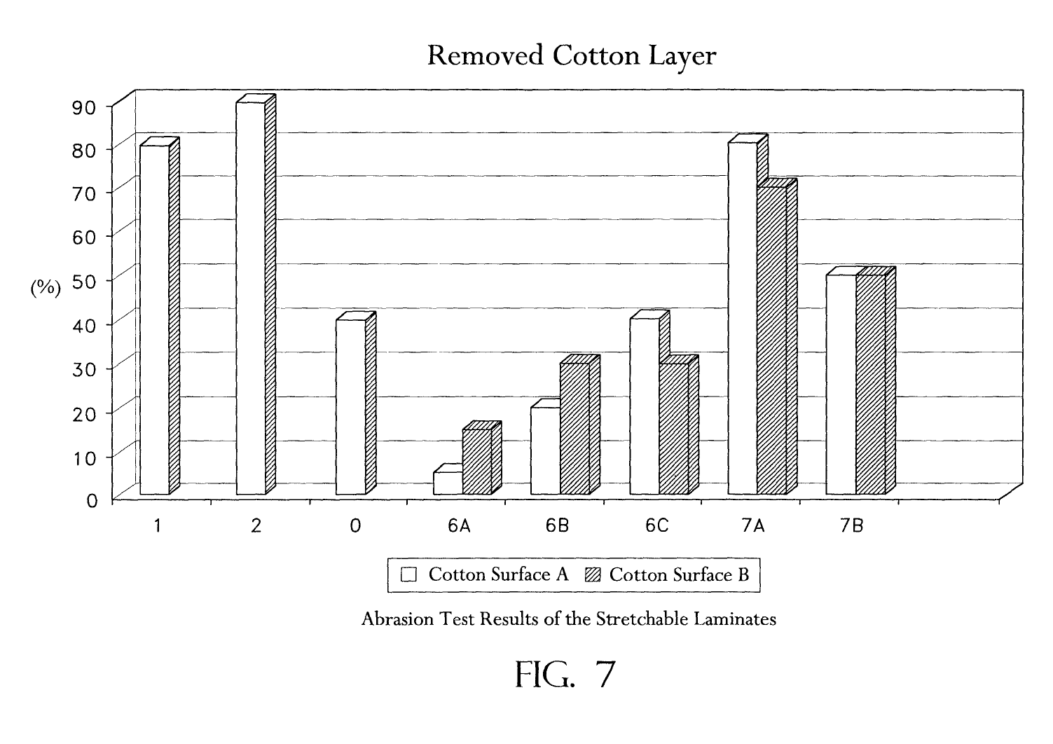

The abrasion test results are shown in FIG. 7. In comparing the samples, reference should also be made to the oven temperature during consolidation. Higher consolidation temperatures correspond to lower abrasion for samples of the same composition. The heavier core layer also corresponds to lower abrasion. Sample 2 and sample 3 have the same composition. The only difference between them is that the cotton containing web in sample 2 was under the core layer, contacting the smooth calendar roller, and the cotton containing web in sample 3 was over the core layer, contacting the diamond patterned calendar roller. The raised diamond pattern served to better compress the cotton containing web into the spunbond polypropylene core at the raised diamond areas. As shown in FIG. 7, sample 3 only lost about 40% of the cotton containing surface compared to 90% for sample 2.

While the invention has been particularly shown and described with reference to the preferred embodiments thereof, it will be understood by those skilled in the art that various changes in form and details may be made without departing from the spirit and scope of the invention. For example, the embodiments described herein have monocomponent thermoplastic filament fibers in the core layer and monocomponent staple fibers in the web layer(s). However, bicomponent filament fibers and/or staple fibers with a lower melting point component could also be used in the core layer and web layer(s) respectively, replacing between 10% and 100% of the monocomponent thermoplastic fibers. The bicomponent fibers could be a core/sheath (i.e. core of polypropylene and sheath of lower melting point polyester or a core of PET polyester and a sheath of polypropylene or of a lower melting point copolyester). The bicomponent may be a side-by-side arrangement of the same compositions as the core/sheath fibers. Other bicomponent arrangements are also possible.

Also, the embodiments described herein use a thermal calendar bonding process to bond the surface layer(s) to the core layer. However, other thermal bonding processes such as hot-through-air bonding or ultra-sonic bonding may be used.

What is claimed is:

1. A laminated nonwoven fabric comprising a pre-bonded surface layer thermally bonded to a core layer; said pre-bonded surface layer consisting essentially of cellulosic fibers and thermoplastic staple fibers mixed and pre-bonded; and said core layer consisting essentially of thermoplastic filament fibers wherein said filament fibers are unbonded prior to thermally bonding said surface layer to said core layer.

2. The fabric of claim 1 wherein said surface layer is pre-bonded at a temperature of between about 30° C. and 3° C. below the melting temperature (actual rd/temp 130-150° C.) of said thermoplastic filament fibers, and at a pressure of between about 20 and 150 PLI (actual 60 PLI) over an area of between about 5% and 30% (actual 21%).

3. The fabric of claim 1 wherein said surface layer consists essentially of between 10 weight-% and 90 weight-% cotton fibers having a length of between about 0.2 inches and 2.0 inches and a diameter of between about 5 μm and 30 μm, and the remaining portion of said surface layer consists of polypropylene staple fibers having a length of between about 0.2 inches and 4.0 inches and a denier of between about 1 and 10.

4. The fabric of claim 1 wherein said surface layer consists essentially of between 20 weight-% and 80 weight-% cotton fibers having a length of between about 0.5 inches and 2.0 inches and a denier of between about 8 μm and 20 μm, and the remaining portion of said surface layer consists of polypropylene staple fibers having a length of between about 1.0 inches and 2.0 inches and a denier of between about 1.2 and 1.4.

5. The fabric of claim 1 wherein said surface layer consists essentially of between 40 weight-% and 60 weight-% cotton fibers having a length of between about 0.5 inches and 1.2 inches and a denier of between about 8 μm and 30 μm, and the remaining portion of said surface layer consists of polypropylene staple fibers having a length of between about 1.0 inches and 2.0 inches and a denier of between about 1.2 and 1.4.

6. The fabric of claim 1 or 2 wherein said surface layer is bonded to said core layer using a thermal calendar wherein the patterned roller temperature is set at between about 30° C. and 3° C. below the melting temperature of said thermoplastic filament fibers; the smooth roller temperature is set at between about 27° C. and 5° C. below the melting temperature of said thermoplastic filament fibers; the nip pressure is set at between about 200 and 800 PLI; and the patterned roller covers an area of between about 5% and 40%.

7. The fabric of claim 5 wherein said core layer is comprises of spunbond polypropylene filament fibers.

8. The fabric of claim 7 wherein the weight of said core layer is between about 5 g/m² and 100 g/m² and the weight of said web layer is between about 10 g/m² and 60 g/m² (10-60 g/m²).

9. The fabric of claim 7 wherein the weight of said core layer is between about 10 g/m² and 50 g/m² and the weight of surface layer is between about 10 g/m² and 60 g/m².

10. The fabric of claim 1 or 9 which is consolidated in the machine direction, and is elastic in the cross-machine direction and heat-fixed in the longitudinal direction.

11. The fabric of claim 1 or 9 which is consolidated in the cross-machine direction, and is elastic in the machine direction and heat-fixed in the longitudinal direction.

12. The fabric of claim 11 wherein the instantaneous elastic recovery at 50% elongation is greater than 40% as measured by physically stretching the laminate to an elongation of 50%, releasing the fabric and allowing one minute for recovery.

13. The fabric of claim 11 wherein the strike-through time is greater than 30 seconds as measured by EDANA 150.1-90.

14. The fabric of claim 11 wherein the breaking load in the machine direction is greater than 1.0 kg and the breaking load in the cross-machine direction is greater than 0.25 kg as measured by ASTM D 1117.

15. A laminated nonwoven fabric comprising a pre-bonded surface layer thermally bonded to both sides of a core layer; said pre-bonded surface layer consisting essentially of cellulosic fibers and thermoplastic staple fibers mixed and pre-bonded; and said core layer consisting essentially of thermoplastic filament fibers wherein said filament fibers are unbonded prior to thermally bonding said surface layers to said core layer.

16. The fabric of claim 15 wherein said surface layers are pre-bonded at a temperature of between about 30° C. and 3° C. below the melting temperature (actual rd/temp 130-150° C.) of said thermoplastic filament fibers, and at a pressure of between about 20 and 150 PLI (actual 60 PLI) over an area of between about 5% and 30% (actual 21%).

17. The fabric of claim 15 wherein said surface layers consists of between 10 weight-% and 90 weight-% cotton fibers having a length of between about 0.2 inches and 2.0 inches and a diameter of between about 5 μm and 30 μm, and the remaining portion of said surface layer consists of polypropylene staple fibers having a length of between about 0.2 inches and 4.0 inches and a denier of between about 1 and 10.

18. The fabric of claim 15 wherein said surface layers consist of between 20 weight-% and 80 weight-% cotton fibers having a length of between about 0.5 inches and 1.2 inches and a denier of between about 8 μm and 20 μm, and the remaining portion of said surface layer consists of polypropylene staple fibers having a length of between about 1.0 inches and 1.5 inches and a denier of between about 1.2 and 1.4.

19. The fabric of claim 15 wherein said surface layers consist of between 40 weight-% and 60 weight-% cotton fibers having a length of between about 0.5 inches and 1.2 inches and a diameter of between about 8 μm and 20 μm, and the remaining portion of said surface layer consists of polypropylene staple fibers having a length of between about 1.0 inches and 1.5 inches and a denier of between about 1.2 and 1.4.

20. The fabric of claim 15 or 16 wherein said surface layers are bonded to said core layer using a thermal calendar wherein the patterned roller temperature is set at between about 30° C. and 3° C. below the melting temperature of said thermoplastic filament fibers; the smooth roller temperature is set at between about 27° C. and 5° C. below the melting temperature of said thermoplastic filament fibers; the nip pressure is set at between about 100 and 700 PLI; and the patterned roller covers an area of between about 5% and 40%.

21. The fabric of claim 19 wherein said core layer comprises of spunbond polypropylene filament fibers.

22. The fabric of claim 21 wherein the weight of said core layer is between about 5 g/m² and 100 g/m² and the weight of surface layer is between about 10 g/m² and 60 g/m².

23. The fabric of claim 21 wherein the weight of said core layer is between about 10 g/m² and 50 g/m² and the weight of surface layer is between about 10 g/m² and 40 g/m².

24. The fabric of claim 15 or 23 which is consolidated in the machine direction, and is elastic in the cross-machine direction and heat-fixed in the cross-direction.

25. The fabric of claim 15 or 23 which is consolidated in the cross-machine direction, and is elastic in the machine direction and heat-fixed in the cross-direction.

26. The fabric of claim 25 wherein the instantaneous elastic recovery at 50% elongation is greater than 40% as measured by physically stretching the laminate to an elongation of 50%, releasing the fabric and allowing one minute for recovery.

27. The fabric of claim 25 wherein the strike-through time is greater than 30 seconds as measured by EDANA 150.1-90.

28. The fabric of claim 25 wherein the breaking load in the machine direction is greater than 1.0 kg and the breaking load in the cross-machine direction is greater than 0.25 kg as measured by ASTM D 1117.

29. A stretchable laminated nonwoven fabric resulting from: forming one or two pre-bonded surface layers comprising of cotton fibers and thermoplastic staple fibers; introducing said pre-bonded surface layer or layers on one or both sides of a core layer comprising of unbonded thermoplastic filament fibers on a spunbond processing line prior to calendaring; and bonding said surface layer or layers to said core layer and simultaneously bonding the filament fibers of said core layer to each other in a single draw through a nip between a smooth calendar roller and a patterned calendar roller.

30. A method of fabricating a stretchable laminated nonwoven fabric comprising the steps of: forming one or two pre-bonded surface layers consisting essentially of cotton fibers and thermoplastic staple fibers; introducing said pre-bonded surface layer or layers on one or both sides of a core layer comprising of unbonded thermoplastic filament fibers on a spunbond processing line prior to calendaring; and bonding said surface layer or layers to said core layer and simultaneously bonding the filament fibers of said core layer to each other in a single draw through a nip between a smooth calendar roller and a patterned calendar roller.

31. A method of fabricating a stretchable laminated nonwoven fabric comprising the steps of: carding one or more surface layers comprising of cotton fibers and thermoplastic staple fibers; introducing said carded surface layers on one or both sides of a core layer comprising of unbonded thermoplastic filament fibers on a spunbond processing line prior to calendaring; and bonding said surface layer or layers to said core layer and simultaneously bonding the filament fibers of said core layer to each other and bonding the fibers of said surface layer or layers to each other in a single draw through a nip between a smooth calendar roll and a patterned calendar roll.
